(19) United States
(12) Patent Application Publication
(10) Pub. No.: US 2024/0174286 A1
(43) Pub. Date: May 30, 2024

(54) Apparatus and Method for Damping a Motor-Assisted Steering System of a Vehicle

(71) Applicant: Robert Bosch GmbH, Stuttgart (DE)

(72) Inventors: Andreas Stuetz, Gschwend (DE); Marcel Gross, Schwaebisch Gmuend (DE); Bastian Beck, Schwaebisch Gmuend (DE); Joerg Strecker, Pluederhausen (DE)

(21) Appl. No.: 18/519,748

(22) Filed: Nov. 27, 2023

(30) Foreign Application Priority Data
Nov. 29, 2022 (DE) 10 2022 212 741.2

(51) Int. Cl. B62D 5/04

(52) U.S. Cl. CPC B62D 5/046; B62D 5/0421; B62D 5/0481

(57) ABSTRACT

In a vehicle, apparatus, and method for damping a steering system, which is assisted by a motor of the vehicle, and in which the motor assists a driver of the vehicle in moving a toothed rack of the steering system in a motor mode of the motor and the motor is rotated in a generator mode of the motor by a movement of the toothed rack, a speed of the motor is determined. The damping is performed if the speed exceeds a first threshold value and the motor is operating as a generator, and the damping is suppressed if the motor is operating as a motor or the speed falls below the first threshold value or a second threshold value.

This application claims priority under 35 U.S.C. § 119 to application no. DE 10 2022 212 741.2, filed on Nov. 29, 2022 in Germany, the disclosure of which is incorporated herein by reference in its entirety.

### BACKGROUND

The disclosure proceeds from an apparatus and a method for damping a motor-assisted steering system of a vehicle.

Conventional damping for a motor-assisted steering system sets a damping/braking motor torque as soon as a motor speed of the motor exceeds a particular start speed. This is to avoid speeds that are too high. This is necessary, on the one hand, to prevent too high speeds from being reached, for example by force transmission of the front axle into the steering during dynamic driving maneuvers, such as an escape turn. On the other hand, for mechanical protection of the steering since, at these high speeds and forces, a mechanical limit stop of the steering could otherwise be reached. These high motor speeds or steering speeds are, on the one hand, no longer controllable by the driver, and could lead to damage to the steering system in the worst case.

### SUMMARY

By means of the vehicle, the apparatus, and the method disclosed herein, damping of the steering system suitable for such dynamic driving situations is provided.

The method for damping a motor-assisted steering system of a vehicle provides that the motor assists a driver of the vehicle in moving a toothed rack of the steering system in a motor mode of the motor and the motor is rotated in a generator mode of the motor by a movement of the toothed rack, wherein a speed of the rotor of the motor is determined, and the damping is performed if the speed exceeds a first threshold value and the motor is operating as a generator, and wherein the damping is suppressed if the motor is operating as a motor or the speed falls below the first threshold value or a second threshold value. This means that the damping is activated or deactivated as a function of an operating state of the steering system. The first threshold value is a start speed of the damping. This may also be used to suppress the damping. Alternatively, a second threshold value can be defined for this purpose, e.g., in order to realize hysteresis. This effectively avoids high speeds and enables fast, active steering by the driver themselves if the driver wants to drive a slalom, for example.

Preferably, a direction of a motor torque of the motor and a direction of the speed are determined, wherein generator mode is detected if the directions are opposite to one another, and/or wherein motor mode is detected if the speed and the motor torque have the same direction. Generator mode during a force transmission from outside, i.e., via the steered wheels, is thereby detected.

Preferably, a distance of a toothed rack of the steering system from its limit stop is determined, wherein the damping is performed in generator mode if it is detected that the distance is greater than a third threshold value or equal to a third threshold value and/or is increasing. When steering into the limit stop in the generator-mode case, the damping is activated in order to protect the steering system. When steering out of the limit stop, damping is deactivated.

Preferably, a distance of a toothed rack of the steering system from its limit stop is determined, wherein the damping in generator mode is not suppressed if it is detected that the distance is less than a third threshold value and/or is decreasing. This prevents mechanical damage as a result of reaching the limit stop.

Preferably, it is provided that a total toothed rack torque is determined, wherein generator mode is detected if a sign of the total toothed rack torque deviates from a sign of the speed, and wherein motor mode is detected if the sign of the total toothed rack torque matches the sign of the speed, or wherein a total toothed rack force is determined, wherein generator mode is detected if a sign of the total toothed rack force deviates from a sign of the speed, and wherein motor mode is detected if the sign of the total toothed rack force matches the sign of the speed. This means that generator mode is calculated as a function of the applied total toothed rack force or of the motor torque equivalent to this force. In the case of identical signs between motor torque and rotor speed, motor mode is assumed. In the case of different signs, generator mode is assumed.

Preferably, it is provided that the total toothed rack torque is determined as a function of a sum of a motor torque of the motor and a steering torque generated by a driver of the vehicle, or that the total toothed rack force is determined as a function of a sum of a force generated by the motor and a steering force generated by a driver of the vehicle.

Preferably, the sum is smoothed by means of a filter and the total toothed rack torque or the total toothed rack force is determined as a function of the smoothed sum. This increases the robustness of the distinction between generator and motor mode.

The apparatus for damping a motor-assisted steering system of a vehicle in which the steering system comprises a toothed rack provides that the apparatus comprises a sensor for sensing a steering torque that a driver of the vehicle generates to move the toothed rack, or a sensor for sensing a steering force that a driver of the vehicle generates to move the toothed rack, and the motor for assisting the driver in moving the toothed rack of the vehicle, wherein the apparatus comprises a computing device designed to perform the method. This apparatus has advantages corresponding to those of the method.

The vehicle comprising the apparatus has advantages corresponding to the advantages of the apparatus.

### BRIEF DESCRIPTION OF THE DRAWINGS

Further advantageous embodiments can be taken from the following description and the drawing. Shown in the drawing are:

FIG. 1 a schematic representation of a vehicle with an apparatus for damping a motor-assisted steering system of a vehicle, and

FIG. 2 a flowchart with steps in a method for damping a motor-assisted steering system of the vehicle.

### DETAILED DESCRIPTION

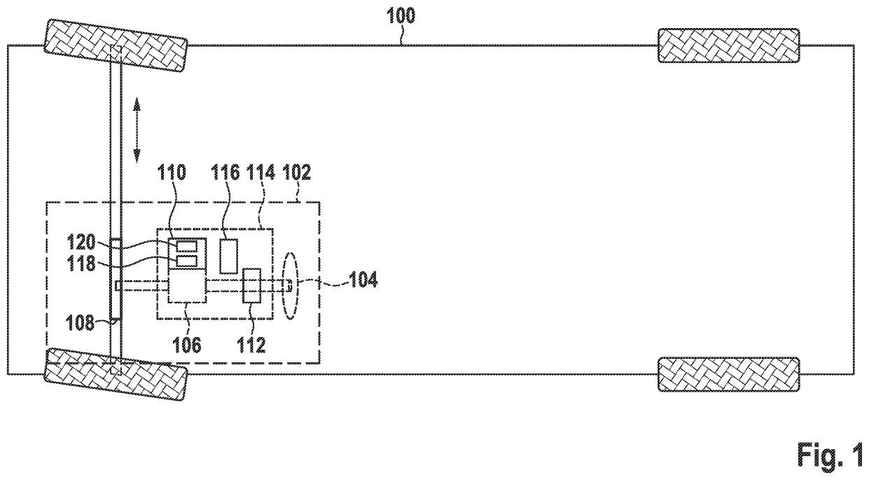

FIG. 1 schematically shows a vehicle 100 with a steering system 102.

The steering system 102 comprises a manual operating element, such as a steering wheel 104, which is connected via a steering gear 106 to a toothed rack 108 in order to move the toothed rack 108.

The steering system 102 comprises a motor 110 designed to assist a driver of the vehicle 100 in steering, i.e., in moving the toothed rack 108 by means of the manual operating element.

The motor 110 is designed to set, in a motor mode of the motor 110, a motor torque assisting the driver.

In the example, the motor torque acts via the steering gear 106 on the toothed rack 108.

The motor 110 is rotated by a movement of the toothed rack 108 in a generator mode of the motor 110. In the example, the toothed rack 108 acts via the steering gear 106 on motor 110.

The steering system 102 comprises a sensor 112 for sensing a steering torque that the driver of the vehicle generates to move the toothed rack 108. For example, the steering torque is a torque applied by the manual operating element. The manual operating element may enable the driver to generate this torque themselves or may comprise a motor that generates this torque according to a driver's request. This means that a driver-generated steering torque or a driver-generated steering force is applied either directly by the driver themselves or by means of the motor according to the demand of the driver. In the example, the steering torque is a torque applied by the driver via the steering wheel 104.

The steering system may comprise a sensor for sensing a steering force that the driver generates to move the toothed rack 108. This sensor may be provided in addition to or instead of the sensor 112 for sensing the steering torque.

FIG. 1 shows an apparatus 114 for damping the steering system 102 assisted by the motor 110. In the example, the vehicle 100 comprises the apparatus 114.

The apparatus 114 comprises the motor 110 and the sensor 112 for sensing the steering torque, a computing device 116, an interface or a sensor 118 for sensing a motor torque at the motor 110, and a sensor 120 for sensing a speed of the motor 110. It may be provided that the motor torque at the motor 110 is a desired motor torque received via the interface. It may be provided that the motor torque at the motor 110 is an actual motor torque sensed by the sensor 120.

It may be provided that the apparatus 114 comprises the sensor for sensing the steering force instead of or in addition to the sensor 112 for sensing the steering torque. It may be provided that instead of or in addition to the sensor 118 for sensing the motor torque, the apparatus 114 is designed to determine the motor torque as a function of another variable that characterizes the motor torque, e.g., a current flowing in the motor 110. It may be provided that instead of or in addition to the sensor 110 for sensing the speed of the motor 110, the apparatus 114 is designed to determine the speed as a function of another variable that characterizes the speed, e.g., a speed in the steering gear 106 or the current flowing in the motor 110.

The computing device 116 is designed to perform a method described below for damping the steering system 102 assisted by the motor 110.

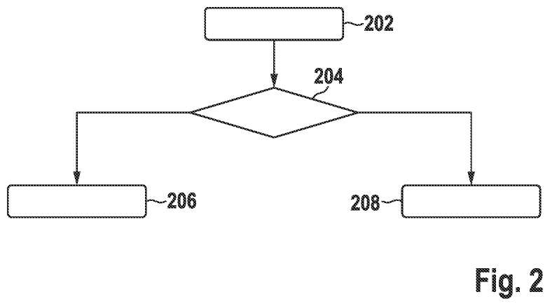

FIG. 2 shows steps of the method.

The method provides that the motor 110 assists the driver of the vehicle 100 in moving the toothed rack 108 in its motor mode and is rotated by a movement of the toothed rack 108 in its generator mode.

In a step 202, information for determining an operating state of the steering system 102 is determined and/or sensed.

In the example, a total toothed rack torque M_{S} is determined as a function of a sum of the motor torque M_{M} of the motor 110 and the steering torque M_{F} generated by the driver of the vehicle 100. For example, the total toothed rack torque M_{S} is determined as a function of an inertia/and an angular acceleration \ddot{φ} of inertial masses in the steering system 102, as well as a gear ratio i in the steering gear 106:

M_{S}=M_{M}+(M_{F}i)−J\ddot{φ}

It may also be provided that instead of the total toothed rack torque, a total toothed rack force is determined as a function of a sum of a force generated by the motor 110 and a steering force generated by a driver of the vehicle 100.

It may be provided that the sum is smoothed by means of a filter and the total toothed rack torque or the total toothed rack force is determined as a function of the smoothed sum.

In the example, the speed of the motor 110 is also determined.

It may be provided that a direction of the motor torque of the motor 110 and a direction of the speed are determined.

It may be provided that a distance of the toothed rack 108 from its limit stop is determined.

In a step 204, it is decided whether the damping is to be performed or to be suppressed.

In the example, it is decided that the damping is to be performed if the speed exceeds the first threshold value and the motor is operating as a generator. In the example, the first threshold value is a start speed of the damping. This means that the damping is to set a braking torque if the start speed of the damping is exceeded.

It may be provided to decide that the damping is to be performed in generator mode if it is detected that the distance of the toothed rack 108 to its limit stop is greater than a third threshold value or equal to a third threshold value and/or is increasing. This means that the damping is performed in generator mode if steering out of the limit stop is detected. The third threshold value is, for example, an applicable parameter.

It may be provided to decide that the damping in generator mode is to be suppressed if it is detected that the distance is less than a third threshold value and/or is decreasing. This makes it possible to allow generator mode in this situation in order to protect against mechanical damage by the limit stop, without thereby detecting the force transmission from outside, i.e., via the steered wheels.

If it is decided that the damping is to be performed, a step 206 is performed.

In the example, it is decided that the damping is to be suppressed if the motor 110 is operating as a motor or the speed falls below the first threshold value or a second threshold value. As an alternative to the first threshold value, a second threshold value is used that is greater than or less than the first threshold value. Hysteresis of the damping is thereby realized.

If it is decided that the damping is to be suppressed, a step 208 is performed.

It may be provided that generator mode is detected if the directions of motor torque and torque are opposite to one another. It may be provided that generator mode is detected if a sign of the total toothed rack torque deviates from a sign of the speed.

It may be provided that motor mode is detected if the speed and the motor torque have the same direction. It may be provided that motor mode is detected if the sign of the total toothed rack torque matches the sign of the speed.

It may be provided that generator mode is detected if a sign of the total toothed rack force deviates from a sign of the speed. It may be provided that motor mode is detected if the sign of the total toothed rack force matches the sign of the speed.

It may be provided that, in order to avoid jittering, the detected generator mode is provided with an applicable run-on time. For example, after the damping is performed first, the damping is performed for a period of time regardless of whether generator mode or motor mode is detected. For example, the steps 202 and 204 are not performed in the method during the period of time, or the step 206 is performed during the method for the period of time.

In step 206, the damping is performed.

In step 208, the damping is suppressed.

Subsequently, the step 202 is performed, for example.

1. A method for damping a steering system that is assisted by a motor of a vehicle in which the motor is configured to, in a motor mode, assist a driver of the vehicle in moving a toothed rack of the steering system and, in a generator mode, be rotated by a movement of the toothed rack, the method comprising:
determining a speed of the motor;
performing a damping if the speed exceeds a first threshold value and the motor is operating in the generator mode; and
suppressing the damping if the motor is in the motor mode or the speed falls below the first threshold value or a second threshold value.

2. The method according to claim 1, further comprising:
determining a first direction of a motor torque of the motor;
determining a second direction of the speed of the motor; and
detecting the generator mode in response to the first and second directions being opposite to one another and/or detecting the motor mode in response to the first and second speeds having the same direction.

3. The method according to claim 1, further comprising:
determining a distance of the toothed rack of the steering system from a limit stop of the toothed rack,
wherein the damping is performed in the generator mode if it is detected that the distance is greater than or equal to a third threshold value, and/or the distance is increasing.

4. The method according to claim 1, further comprising:
determining a distance of the toothed rack of the steering system from a limit stop of the toothed rack,
wherein the damping in generator mode is not suppressed if the distance is less than a third threshold value, and/or the distance is decreasing.

5. The method according to claim 1, further comprising one of the following:
determining a total toothed rack torque, detecting the generator mode in response to a sign of the total toothed rack torque deviating from a sign of the speed, and detecting the motor mode in response to the sign of the total toothed rack torque matching the sign of the speed; or
determining a total toothed rack force, detecting the generator mode in response to a sign of the total toothed rack force deviating from a sign of the speed, and wherein detecting the motor mode in response to the sign of the total toothed rack force matching the sign of the speed.

6. The method according to claim 5, wherein:
the determining of the total toothed rack torque includes determining the total toothed rack torque as a function of a sum of a motor torque of the motor and a steering torque generated by a driver of the vehicle, or
the determining of the total toothed rack force includes determining the total toothed rack force as a function of a sum of a force generated by the motor and a steering force generated by a driver of the vehicle.

7. The method according to claim 6, further comprising:
smoothing the sum of the motor torque of the motor or the sum of the force generated by the motor via a filter,
wherein the total toothed rack torque or the total toothed rack force is determined as a function of the smoothed sum.

8. An apparatus for damping a steering system of a vehicle, said steering system including a toothed rack, the apparatus comprising:
a sensor configured to sense one of (i) a steering torque that a driver of the vehicle generates to move the toothed rack and (ii) a steering force that the driver of the vehicle generates to move the toothed rack;
a motor configured to assist the driver in moving the toothed rack of the vehicle; and
a computing device configured to:
determine a speed of the motor;
perform a damping if the speed exceeds a first threshold value and the motor is operating in the generator mode; and
suppress the damping if the motor is in the motor mode or the speed falls below the first threshold value or a second threshold value.

9. A vehicle comprising:
a steering system having a toothed rack; and
an apparatus for damping the steering system, the apparatus comprising:
a sensor configured to sense one of (i) a steering torque that a driver of the vehicle generates to move the toothed rack and (ii) a steering force that the driver of the vehicle generates to move the toothed rack;
a motor configured to assist the driver in moving the toothed rack of the vehicle; and
a computing device configured to:
determine a speed of the motor;
perform a damping if the speed exceeds a first threshold value and the motor is operating in the generator mode; and
suppress the damping if the motor is in the motor mode or the speed falls below the first threshold value or a second threshold value.
